(19) United States
(12) Patent Application Publication
(10) Pub. No.: US 2019/0186664 A1
(43) Pub. Date: Jun. 20, 2019

(54) HOSE COUPLING ASSEMBLY

(71) Applicant: GATES CORPORATION, Denver, CO (US)

(72) Inventors: Marvin Miller, Westminster, CO (US); Keith E. Zulauf, Castle Rock, CO (US); Stephen M. Pamas, Denver, CO (US); Charles C. Gray, Parker, CO (US); Wesley Gray Alvis, Greenwood Village, CO (US)

(21) Appl. No.: 15/843,760

(22) Filed: Dec. 15, 2017

(51) Int. Cl. F16L 37/091; F16L 37/084; F16L 37/098

(52) U.S. Cl. CPC F16L 37/091; F16L 37/098; F16L 37/0845

(57) ABSTRACT

A hose coupling assembly includes a male stem, a ferrule, and a retainer for coupling the ferrule to the male stem. The male stem may include an elongated body with a latch groove, and the ferrule may include a latch. The retainer may be disposed on the male stem and may be configured to couple the ferrule to the male stem such that the latch is aligned with the latch groove. A method of assembling a hose coupling assembly may include contacting an inner surface of a retainer with a shoulder of a male stem; deflecting, via the shoulder, a retention feature of the retainer; aligning a portion of the retention feature with a latch groove of the male stem; contacting a latch of a ferrule with an outer surface of the retention feature; deflecting, via the latch, the retention feature; and aligning the latch with the latch groove.

### FIELD OF THE DISCLOSURE

This disclosure relates generally to fluid couplings, and more specifically to a hose coupling assembly including a male stem and a ferrule for attachment to a hose.

### BACKGROUND

Couplings that are attached to an end of a hose typically include a male stem that is insertable into a hose end and a ferrule that is concentric with the male stem. Together, the male stem and ferrule define an annular cavity for receiving the hose end. This type of coupling typically is retained by positioning the hose end in the annular cavity between the ferrule and stem, and pinching the hose end via the ferrule and stem such as by either radially reducing at least a portion of the ferrule or by radially increasing the size of the male stem. Crushable ferrules generally are preferred for accurately controlling the pinching process. For example, radially reducing the size of a ferrule by crushing it to a smaller diameter may be accomplished through crimping processes that use a plurality of circumjacently arranged die fingers.

For convenience of assembly, the ferrule may be pre-attached to the male stem by the manufacturer, such as by crimping an end portion of the ferrule to the male stem, thereby creating a one-piece coupling that subsequently can be attached to the hose end by the assembler. While preattachment of the ferrule to the male stem has advantages associated with reducing the number of parts during the hose attachment process, it introduces a disadvantage as to the number of couplings required for a line of hose sizes because some hoses require the same size stem but different size ferrules. For example, three different-sized ferrules may be used with the same size stem for coupling one-half inch inner diameter hose having different tube, reinforcement, and cover combinations. Consequently, in this example three different couplings would be stocked in inventory, with each coupling including the same size stem but different-sized ferrules to accommodate the different hose combinations.

Some assemblers prefer to select an appropriate ferrule for a hose when it is to be crimped on a hose so as to minimize inventory and thus maintain two-piece coupling components (i.e., separate male stems and ferrules) in inventory for assembly during the hose attachment process. However, the geometry of the ferrules used in two-piece couplings typically are different than the ferrules used in one-piece couplings to facilitate assembly of the two-piece couplings, thus requiring the manufacturer to manufacture different ferrules for the same hose configuration depending on whether the ferrules are intended to be used in one-piece or two-piece couplings. Also, when assembling the two-piece couplings, the ferrule sometimes is misaligned with the stem during attachment of the ferrule to the stem, thereby rendering the resulting coupling unusable.

### SUMMARY

In an embodiment, a hose coupling assembly is provided. The hose coupling assembly includes a male stem, a ferrule, and a retainer configured to couple the ferrule to the male stem. The male stem may include an elongated body with a latch groove, and the ferrule may include a latch. The retainer may be disposed on the male stem and may be configured to couple the ferrule to the male stem such that the latch is aligned with the latch groove.

In an embodiment, a method of assembling a hose coupling assembly is provided. The method may include contacting an inner surface of a retainer with a shoulder of a male stem; deflecting, via the shoulder, a retention feature of the retainer radially outwards; aligning a portion of the retention feature with a latch groove defined in the male stem; contacting a latch of a ferrule with an outer surface of the retention feature; deflecting, via the latch, the retention feature radially inward; and aligning the latch with the latch groove of the male stem.

The foregoing has outlined rather broadly the features and technical advantages of the present disclosure in order that the detailed description of the disclosure that follows may be better understood. Additional features and advantages of the disclosure will be described hereinafter which form the subject of the claims. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features, which are believed to be characteristic of the disclosure both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings, which are incorporated in and form part of the specification in which like numerals designate like parts, illustrate embodiments of the present disclosure and together with the description, serve to explain the principles of the disclosure. In the drawings:

FIG. 1 is an isometric view of an embodiment of a hose coupling assembly in an assembled position;

FIG. 2 is another isometric view of the hose coupling assembly of FIG. 1 with a connected hose;

FIG. 3 is an exploded isometric view of the hose coupling assembly of FIG. 1;

FIG. 4 is a cross-sectional view along line 4-4 of the hose coupling assembly of FIG. 3;

FIG. 5 is an isometric view of an embodiment of a retainer;

FIG. 6 is another isometric view of the retainer of FIG. 5;

FIG. 7 is a cross-sectional view along line 7-7 of the retainer of FIG. 5;

FIG. 8 is a cross-sectional view along line 8-8 of the hose coupling assembly of FIG. 1;

FIG. 9 is an enlarged view of a portion of the cross-sectional view of FIG. 8;

FIG. 10 is an isometric view of a retainer in a first position relative to a stem;

FIG. 11 is a cross-sectional view along line 11-11 of the stem and retainer of FIG. 10;

FIG. 12 is an isometric view of the retainer in a second position relative to the stem;

FIG. 13 is a cross-sectional view along line 13-13 of the stem and retainer of FIG. 12;

FIG. 14 is an isometric view of the retainer in the second position relative to the stem, and a ferrule in a third position relative to the stem and retainer;

FIG. 15 is a cross-sectional view along line 15-15 of the stem, retainer, and ferrule of FIG. 14;

FIG. 16 is a cross-sectional view of a second embodiment of a hose coupling assembly;

FIG. 17 is a cross-sectional view of a third embodiment of a hose coupling assembly;

FIG. 18 is a diagram of a method of assembling a hose coupling assembly; and

FIG. 19 is an isometric view of the retainer of FIG. 16.

### DETAILED DESCRIPTION

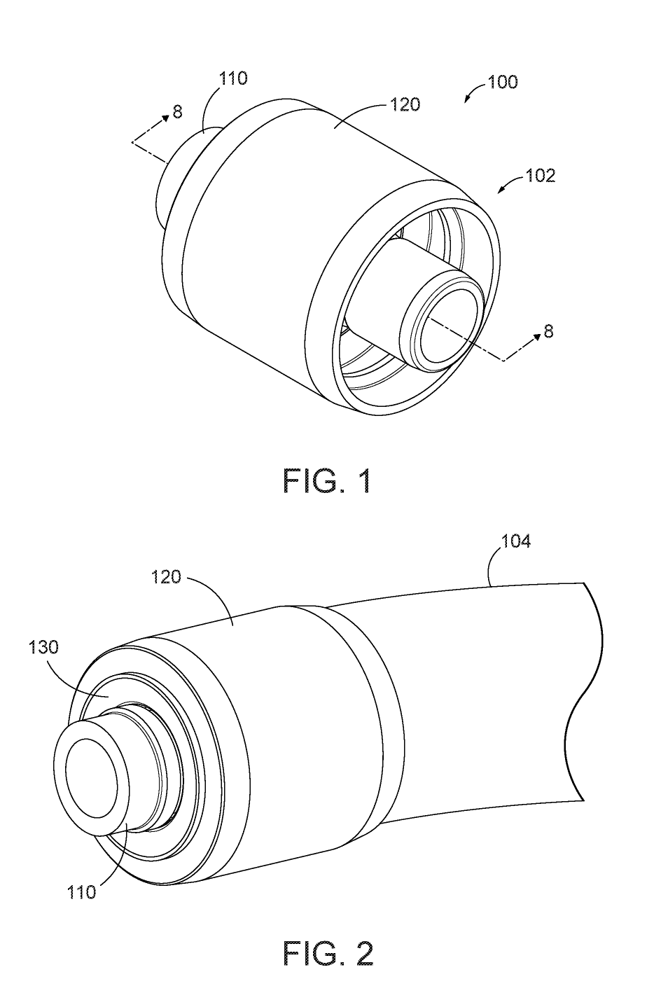

FIGS. 1-18 generally relate to a hose coupling assembly including a male stem, a ferrule, and a retainer. The retainer may enable the assembler to use ferrules designed for one-piece couplings, thereby allowing the manufacturer to manufacture a single type of ferrule regardless of whether the ferrules are intended to be used in one-piece or two-piece couplings. Additionally or alternatively, the retainer may axially locate the ferrule relative to the male stem, thereby reducing the likelihood of misalignment of the ferrule relative to the stem during assembly. For example, the retainer may align a latch of the ferrule with a latch groove of the stem. After alignment, an assembler may stake (e.g., crimp) the ferrule to the stem during attachment of a hose to the hose coupling assembly.

To install the retainer onto the male stem, the assembler may slide the retainer onto the male stem, and the retainer may autonomously snap into its intended position. For example, the retainer may include one or more retention features (e.g., resilient arms or prongs) configured to contact an external shoulder on the male stem during installation of the retainer onto the stem. The stem shoulder may force the one or more resilient arms to elastically deform outwardly during movement of a proximal portion of the resilient arms past the stem shoulder. Once the proximal portion of the resilient arms pass by the stem shoulder, the resilient arms may return to their non-deformed configuration, and the proximal portion of the resilient arms may be seated in a groove formed in the exterior surface of the male stem adjacent to the shoulder. When seated in the groove, the resilient arms may restrain the retainer from moving axially along the length of the stem.

To install the ferrule onto the male stem, the assembler may slide the ferrule onto the male stem, and the ferrule may autonomously snap into its intended position. For example, the one or more resilient arms of the retainer may be configured to contact the latch of the ferrule during installation of the ferrule onto the stem. The ferrule latch may force a distal portion of the resilient arms to elastically deform inwardly during movement of the latch past the distal portion of the resilient arms. Once the ferrule latch passes by the distal portion of the resilient arms, the resilient arms may return to their non-deformed configuration to restrict the ferrule from moving axially along the length of the stem. For example, the ferrule latch may be trapped between a base (e.g., a backstop or collar) of the retainer and the distal portion of the resilient arms. In this trapped position, the ferrule latch may be axially aligned with the groove formed in the stem.

To attach a hose to the hose coupling assembly, an end of the hose may be inserted into an annular cavity defined between the stem and the ferrule. Then, the ferrule may be plastically deformed radially inward (e.g., crimped) to pinch the hose end between the crushed ferrule and the stem. During the crimping process, the ferrule latch is plastically deformed radially inward into the groove formed in the stem to ensure the ferrule is axially fixed to the stem.

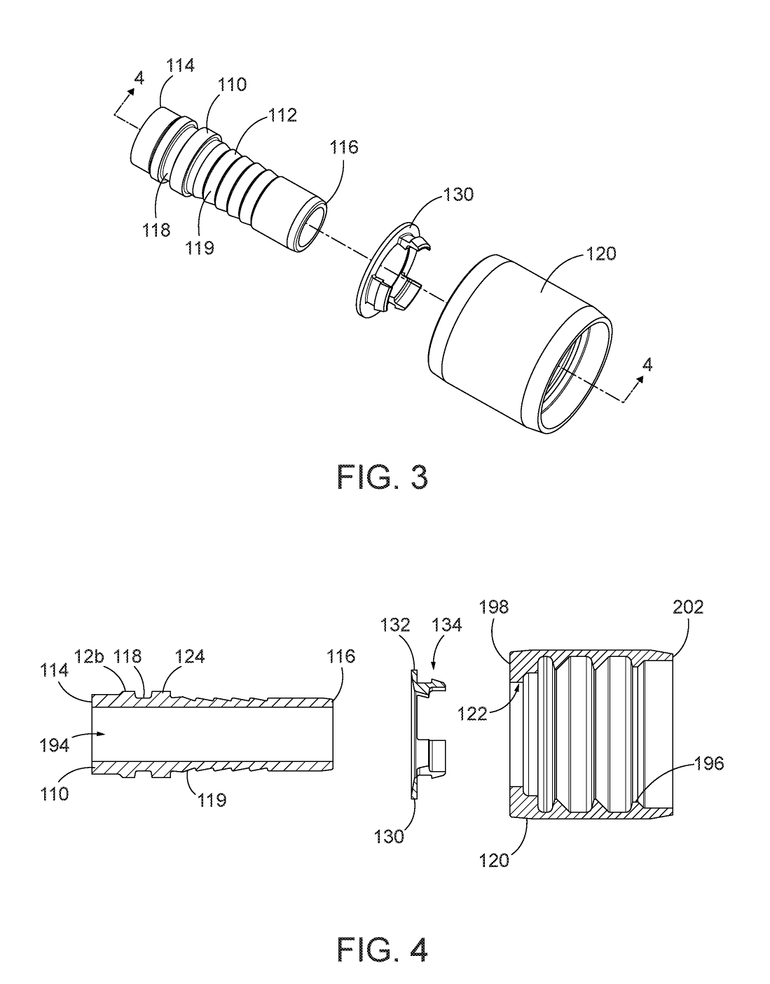

FIGS. 1-4 show an embodiment of a hose coupling assembly. FIG. 1 is an isometric view a hose coupling assembly 100 in an assembled position 102. FIG. 2 is an isometric view of the hose coupling assembly 100 of FIG. 1 with a connected hose 104. FIG. 3 is an exploded isometric view of the hose coupling assembly 100 of FIG. 1. FIG. 4 is a cross-sectional view along line 4-4 of the hose coupling assembly 100 of FIG. 3. As shown in FIGS. 2-4, the hose coupling assembly 100 may include a male stem 110, a ferrule 120, and a retainer 130. In some examples, the hose coupling assembly 100 also includes a hose 104.

As shown in FIGS. 3 and 4, in some examples, the male stem 110 may have an elongated body 112 with a first end 114 opposite a second end 116. The male stem 110 may be serrated and have a central bore 194 extending through the length of the elongated body 112. An annular groove 118, referred to herein as a latch groove, may be formed in the elongated body 112 between the first end 114 and the serrations 119. A first shoulder 124 may extend radially outward from the elongated body 112 and may be positioned between the latch groove 118 and the serrations 119. A second shoulder 126 may be positioned between the latch groove 118 and the first end 114. The second shoulder 126 may extend to the first end 114, or it may be laterally offset from the first end 114. In some examples, the first shoulder 124 defines one side wall of the latch groove 118, and the second shoulder 126 defines an opposite side wall of the latch groove 118. In some examples, there may be multiple latch grooves positioned along the length of the elongated body 112. The latch groove 118 may be formed to receive a portion of a ferrule latch when the hose coupling assembly 100 is coupled to a hose. The first end 114 of the stem may be formed to include a variety of end terminations, such as threads using various classifications, male and female joints, elbows, connection features, etc.

The hose coupling assembly 100 also includes the ferrule 120. In some examples, the ferrule 120 is used to secure the hose to the stem 110 using a crimping or ferrule crushing process. The ferrule 120 may be hollow and generally cylindrical. The internal surface 196 of the ferrule 120 may be textured or shaped to help secure the hose to the stem 110 during the crimping or ferrule crushing process. The ferrule 120 may have a first end 198 and a second end 202. A latch 122 may be positioned adjacent the first end 198. The latch 122 may be formed as a protrusion or lip and extend radially inward towards a center axis of the ferrule 120. The latch 122 may have a diameter that is smaller than an external diameter of the ferrule 120. The latch 122 may be formed to fit into the latch groove 118 of the male stem 110 when the hose coupling assembly 100 is coupled to a hose.

The hose coupling assembly 100 also includes the retainer 130, which in some embodiments may be referred to as a pronged clip. In some examples, the retainer 130 has a collar 132 and a ferrule retention feature 134. The ferrule retention feature 134 may extend away from (e.g., orthogonal to) a surface of the collar 132. The ferrule retention feature 134 may be used to couple the ferrule 120 to the male stem 110. In some examples, the collar 132 may be used as a bumper or a backstop to align the latch 122 of the ferrule 120 with the latch groove 118 of the male stem 110. The collar 132 may also be used to align a connector coupled to or formed adjacent to the first end 114 of the male stem 110. In some examples, the collar 132 may be formed as a washer, such as a Belleville washer.

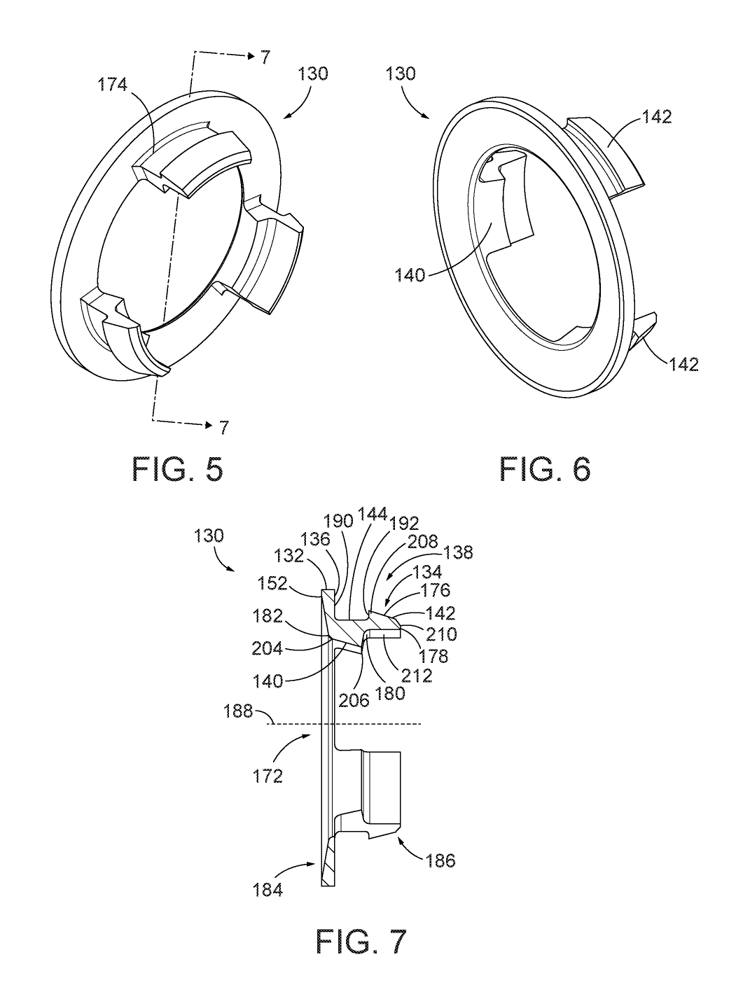

FIGS. 5-7 show an embodiment of the retainer 130. FIG. 5 is an isometric view of an embodiment of the retainer 130. FIG. 6 is another isometric view of the retainer 130 of FIG. 5. FIG. 7 is a cross-sectional view along line 7-7 of the retainer 130 of FIG. 5. In some examples, the retainer 130 includes the collar 132 and the ferrule retention feature 134. The collar 132 may be positioned adjacent a first end 184 of the retainer 130, and the ferrule retention feature 134 may be positioned adjacent a second end 186 of the retainer 130. The collar 132 and ferrule retention feature 134 may be concentric or centered about a central axis 188 of the retainer 130. In the examples of FIGS. 5-7, the collar 132 forms a full ring about the axis 188 and has a complete circumference such that it is not split. In other examples, the collar 132 may have a split circumference, so that the ring formed by the collar 132 is not complete. A split circumference may be used to help increase the ease with which the retainer 130 is positioned about the male stem 110. The collar 132 has a first surface 136 and a second surface 152. In the examples of FIGS. 5-7, the second surface 152 is adjacent the first end 184 of the retainer 130. In some examples, the second surface 152 may be sloped or angled. The slope or angle of the second surface 152 may ease installation when the retainer is positioned about the male stem 110.

The ferrule retention feature 134 extends away from the first surface 136 of the collar 132. In examples where the collar 132 has a split or incomplete circumference, the ferrule retention feature 134 may extend partially or fully around the incomplete circumference of the collar 132. In some examples, the ferrule retention feature 134 includes at least one flexible or resilient arm 138. In some examples, the retainer 130 includes a quantity of flexible arms 138 (e.g., two or more flexible arms 138). In some examples, the flexible arm 138 is curved and extends about a partial circumference of the collar 132. In examples where the collar 132 has a split or incomplete circumference, the flexible arm 138 may extend partially around the entire incomplete circumference of the collar 132.

The flexible arm 138 may include a stem ramp 140 that extends radially inward. The stem ramp 140 has a sloped surface. A first end 204 of the stem ramp 140 is proximate to the first end 184 of the retainer 130. A second end 206 of the stem ramp 140 is proximate to the second end 186 of the retainer 130. The stem ramp 140 may slope inward towards the central axis 188 between the first end 204 and the second end 206. The first end 204 of the stem ramp 140 may be connected to the second surface 152 of the collar 132 at a bevel 182. The second end 206 may be connected to a ferrule ramp 142 at a bevel 180. In some examples, the stem ramp 140 has a length extending from the first end 204 to the second end 206 that is smaller than a length of the latch groove 118. In some examples, the diameter of the stem ramp 140 at the first end 204 may be similar to the diameter of the shoulder 124 of the male stem 110, and larger than the diameter of the latch groove 118 of the male stem 110. The diameter of the stem ramp 140 at the second end 206 may be between the diameter of the latch groove 118 and the shoulder 124 of the male stem 110. In other examples, the stem ramp may be similar in size to the latch groove, or even have an interference fit in the latch groove.

The flexible arm 138 may include the ferrule ramp 142 that extends radially outward, away from the central axis 188. A first end 208 of the ferrule ramp 142 is proximate to the first end 184 of the retainer 130. A second end 210 of the ferrule ramp 142 is proximate to the second end 186 of the retainer 130. The ferrule ramp 142 has at least one sloped surface 176. In some examples, the ferrule ramp 142 has a second sloped surface 178. In some examples, the angles formed by the first sloped surface 176 and the second sloped surface 178 are different. In some examples, the first sloped surface 176 is proximate to the first end 208, and the second sloped surface 178 is proximate to the second end 210. The ferrule ramp 142 may slope inward towards the central axis 188 between the first end 208 and the second end 210. An inside surface 212 of the ferrule ramp 142 may have a generally constant diameter. The diameter formed by the inside surface 212 may be larger than a diameter formed by the shoulder 124 of the male stem 110. In some examples, the ferrule ramp 142 may have a length extending between the first end 208 and the second end 210.

The flexible arm 138 may include a channel 144 formed between the ferrule ramp 142 and the first surface 136 of the collar 132. The channel 144 may have a length that extends between a first end 190 proximate the first end 184 of the retainer 130 and a second end 192 proximate the second end 186 of the retainer 130. The first end 190 of the channel 144 may be formed at least partially by the first surface 136 of the collar 132. The second end 192 of the channel 144 may be formed at least partially by the first end 208 of the ferrule ramp 142. The length of the channel 144 may be larger than a length of the latch 122 of the ferrule 120. The bottom portion of the channel 144 may have a diameter that is smaller than the diameter formed by the latch 122.

In some examples, the retainer 130 may be formed from a semi-rigid material. In some examples, the retainer may be formed from thermoplastic materials such as nylon, polyolefin, thermoplastic elastomer or the like, which may include various additives such as particulate fillers, glass or carbon fiber, anti-degradants, or the like. In some examples, the retainer may be formed using injection molding, 3D printing, milled, or similar manufacturing techniques.

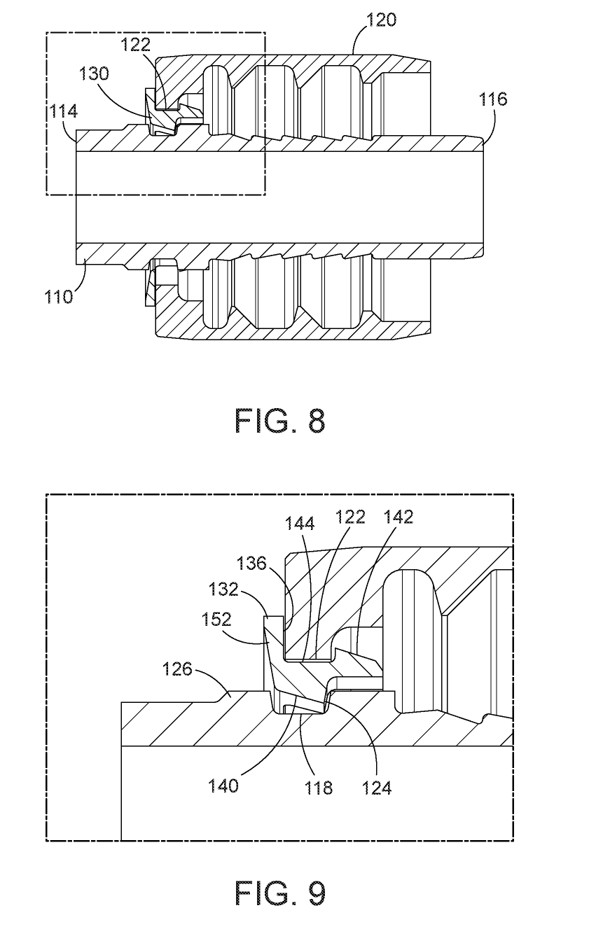

The assembled hose coupling 100 is shown in FIGS. 8-9. FIG. 8 is a cross-sectional view along line 8-8 of the hose coupling assembly of FIG. 1, and FIG. 9 is an enlarged view of a portion of the cross-sectional view of FIG. 8. When the components of the hose coupling assembly 100 are positioned in the assembled position 102, the stem ramp 140 of the retainer 130 is at least partially positioned within the latch groove 118 of the male stem 110. The latch 122 of the ferrule 120 is at least partially positioned within the channel 144 of the retainer 130. In the assembled position 102, the retainer 130 helps to align the latch 122 of the ferrule 120 with the latch groove 118 of the male stem 110. This alignment may allow the ferrule 120 to be loosely coupled with the male stem 110 so that it can freely rotate but remains axially constrained with respect to the male stem 110. The hose coupling 100 may then be assembled or coupled to a hose, and the deformation or crushing of the ferrule 120 during the crimping process will position the latch 122 within the latch groove 118. When the hose coupling assembly 100 is in the assembled position 102, the ferrule 120 may rotate about the male stem 110, but the latch groove 118 and latch 122 remain aligned. In the assembled position 102, the retainer 130 may act as a mechanical device to prevent the ferrule 120 from separating from the male stem 110.

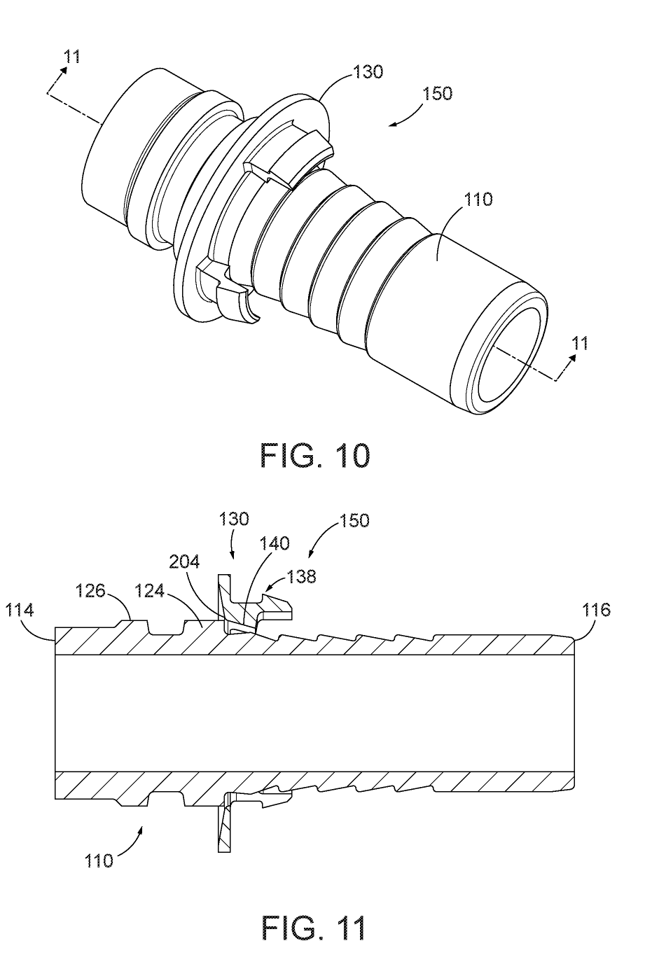

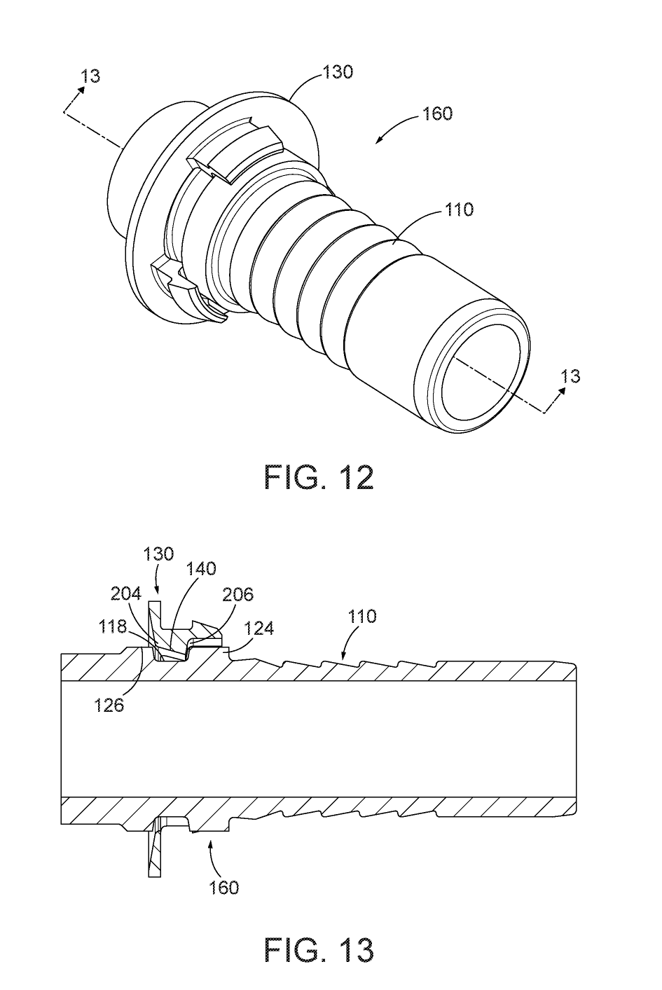

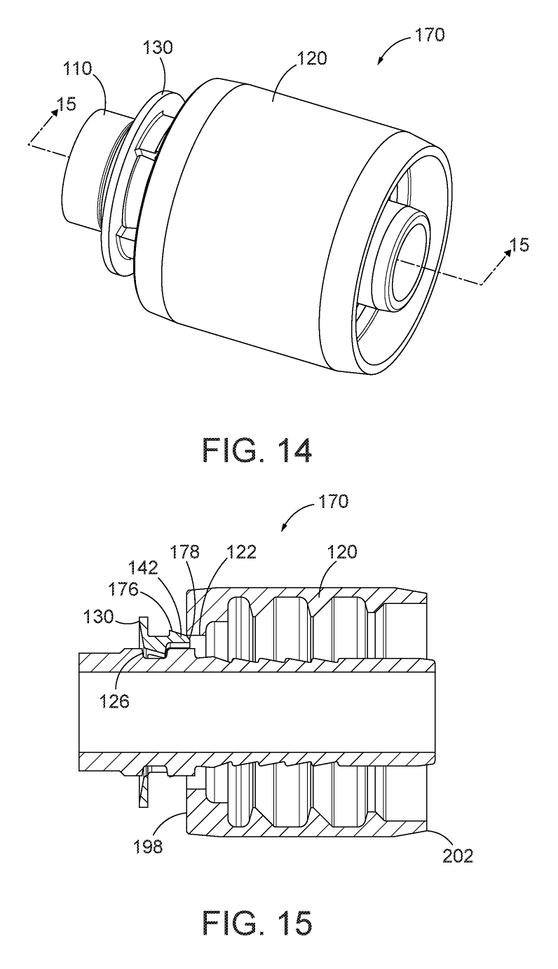

The components of the hose coupling assembly 100 may be assembled together to form the assembled position 102 shown in FIGS. 8-9. In some examples, the hose coupling assembly 100 may be assembled by hand, without the use of a machine to loosely couple or stake the ferrule to the male stem. FIGS. 10-11 show the retainer 130 in a first position 150 relative to the male stem 110. FIGS. 12-13 show the retainer 130 in a second position 160 relative to the male stem 110. FIGS. 14-15 show the retainer 130 in the second position relative to the male stem 110, and the ferrule 120 in a third position 170 relative to the male stem 110. As the components are assembled together, they are moved from the first position 150 to the second position 160 to the third position 170 and finally positioned to create the assembled position 102.

FIGS. 10-11 show the retainer 130 positioned in the first position 150 relative to the male stem 110. FIG. 10 is an isometric view of the stem 110 and the retainer 130, and FIG. 11 is a cross-sectional view along line 11-11 of the stem and the retainer of FIG. 10. In the first position 150, the retainer 130 is positioned between the shoulder 124 and the second end 116 of the male stem 110. The stem ramp 140 of the retainer 130 contacts the shoulder 124. As the first end 184 of the retainer 130 is moved towards the first end 114 of the male stem 110, the stem ramp 140 is positioned against the shoulder 124 and the flexible arm 138 is flexed (e.g., elastically deformed) and is forced radially outward as the stem ramp 140 is sloped. This allows the retainer 130 to continue to be moved towards the first end 114 of the male stem 110.

FIGS. 12-13 show the retainer 130 positioned in the second position 160 relative to the male stem 110. FIG. 12 is a left isometric view of the male stem 110 and the retainer 130, and FIG. 13 is a cross-sectional view along line 13-13 of the male stem 110 and the retainer 130 of FIG. 12. In the second position 160, the retainer 130 is positioned about the shoulder 124 of the male stem 110. At least a portion of the stem ramp 140 of the retainer 130 is positioned within the latch groove 118. The position of the stem ramp 140 within the latch groove 118 allows the retainer 130 to be coupled to the male stem 110 but still allows the retainer 130 to rotate with respect to the male stem 110.

FIGS. 14-15 show the retainer 130 in the second position 160 relative to the male stem 110, and the ferrule 120 in a third position 170 relative to the male stem 110. FIG. 14 is an isometric view of the stem 110, retainer 130, and ferrule 120, and FIG. 15 is a cross-sectional view of the components along line 15-15 of FIG. 14. In the third position 170, the second end 116 of the male stem 110 is inserted through the bore of the ferrule 120. The first end 198 of the ferrule 120 is positioned against the second end 210 of the ferrule ramp 142. In some examples, the latch 122 may contact the second end 210 of the ferrule ramp 142. As the ferrule 120 is moved towards the assembled retainer 130 and male stem 110, the latch 122 contacts the sloped surface of the ferrule ramp 142 and the flexible arm 138 is forced radially inward. The flexing of the flexible arm 138 allows the ferrule 120 to be moved into the assembled position 102.

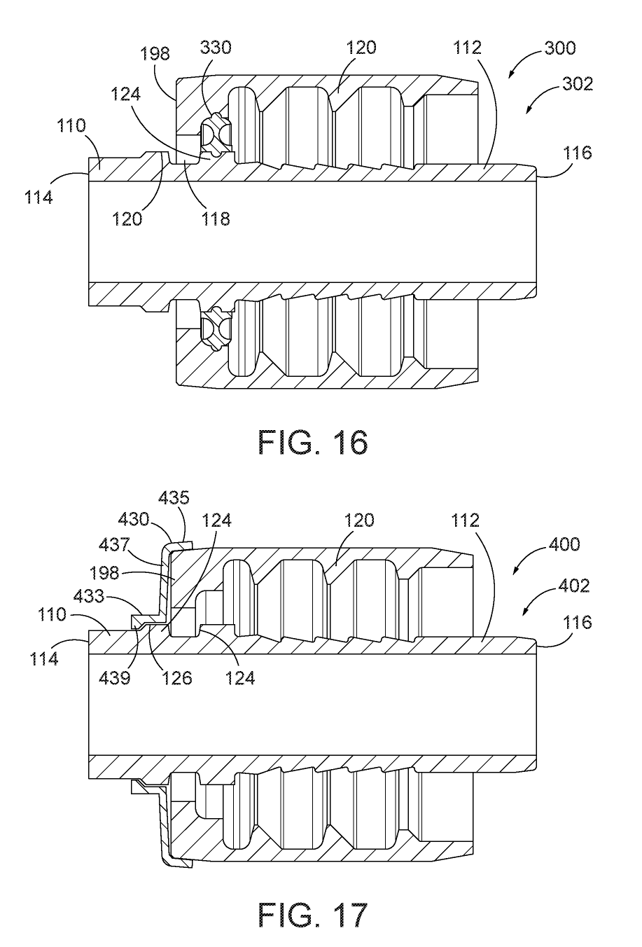

FIG. 16 is a cross-sectional view of a second embodiment of a hose coupling assembly 300. The components of hose coupling assembly 300 may be similar to the components of hose coupling assembly 100. In FIG. 16, the hose coupling assembly 300 is shown in an assembled position 302. The ferrule 120 and male stem 110 are similar to those described with respect to the hose coupling assembly 100. Unlike the assembled position 102, in the assembled position 302, the retainer 330 is positioned adjacent the shoulder 124 of the male stem 110 opposite the latch groove 118, and axially spaced away from the first end 198 of the ferrule 120, towards the second end 202. In this embodiment, the retainer 330 is received in corresponding grooves of the stem 110 and the ferrule 120 located in an annular space between the stem 110 and retainer 330 to axially locate the ferrule 120 relative to the stem 110 during an assembly process. The retainer may have a complete circumference, or be a split ring as shown by retainer 330 in FIG. 19. It may be advantageous for this embodiment to assemble the retainer 330 into or with the ferrule 120 before pushing the resulting partial assembly onto the male stem 110.

FIG. 19 is an isometric view of the retainer 330 of FIG. 16. As shown in FIG. 19, the retainer 330 is a split ring type, such that it has a circumference that is split, incomplete, or partial. The split circumference may allow the retainer 330 to be flexible in size. In an example, the retainer 330 may be flexed inwardly, such that an overall diameter is decreased, or be flexed outwardly, so that the overall diameter is increased. The flexibility of diameter size may allow the retainer 330 to expand to fit over portions of a stem 110, such as the shoulder 124. The flexibility of diameter size may also allow the retainer 330 to be compressed so that it may be received in corresponding grooves of the ferrule 120 and stem 110. In some examples, the retainer 330 may be used with a variety of stems or retainer sizes since the diameter size is flexible.

FIG. 17 is a cross-sectional view of a third embodiment of a hose coupling assembly 400. The components of hose coupling assembly 400 may be similar to the components of hose coupling assembly 100. In FIG. 17, the hose coupling assembly 400 is shown in an assembled position 402. The ferrule 120 and male stem 110 are similar to those described with respect to the hose coupling 100. Unlike in the assembled position 102, in the assembled position 402, the retainer 430 is positioned adjacent to the first end 198 of the ferrule 120. The retainer 430 is positioned about the shoulder 126 of the male stem 110. The retainer 430 may include a first sleeve portion 433 disposed about the elongated body 112 of the stem 110, a second sleeve portion 435 disposed about an outer surface of the ferrule 120, and an abutment portion 437 disposed adjacent the first end 198 of the ferrule 120 and interconnecting the sleeve portions 433, 435. The first sleeve portion 433 and the second sleeve portion 435 may be configured to axially secure the ferrule 120 to the stem 110. For example, the first sleeve portion 433 may be secured to the stem 110 such that the retainer 430 is restrained from moving axially along the length of the stem 110, and the second sleeve portion 435 may be secured to the ferrule 120 such that the ferrule 120 is restrained from moving axially relative to the retainer 430. In some examples, the first sleeve portion 433 is interference fit onto the stem 110, and/or the second sleeve portion 435 is interference fit onto the ferrule 120. In some examples, the first sleeve portion 433 includes a protrusion or lip 439 that extends radially inward towards a center axis of the stem 110, and the lip 439 may be received in an annular groove formed in the elongated body 112 of the stem 110 to restrict relative axial movement between the retainer 430 and the stem 110. Likewise, the second sleeve portion may include a lip (not shown) which may be received into a corresponding annular groove (not shown) formed in the ferrule to restrict relative axial movement between the retainer and the ferrule. Retainer 430 could be separately formed or molded. Alternately, retainer 430 could be formed in situ around the stem and ferrule, for example, by using a heat-shrinkable tube.

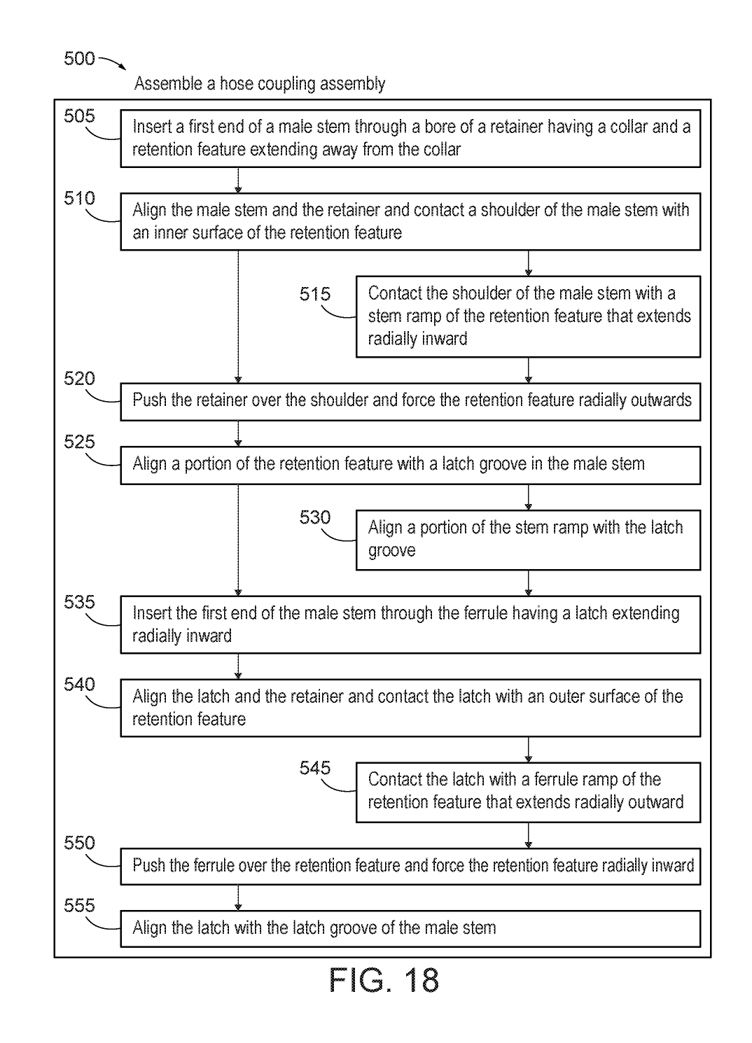

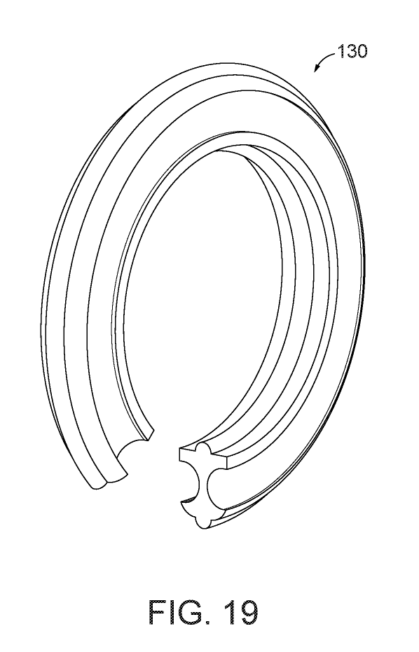

FIG. 18 is a diagram for a method of assembling a hose coupling assembly. The method of assembling a hose coupling assembly 500 may include components similar to those described with respect to hose coupling assembly 100, 300, and 400. In an example, the method 500 may begin with inserting a retainer onto a male stem (step 505). The method 500 may include contacting an inner surface of the retainer with a shoulder of the male stem (step 510). In an example, the inner surface in step 510 may be formed as a stem ramp that extends radially inwards towards a centerline of the retainer (step 515). The method 500 may include pushing the retainer over the shoulder and forcing the retention feature radially outwards (step 520). A retention feature of the retainer may flex outward during step 520 so that the retention feature may ride up and over the shoulder.

The method 500 may include aligning a portion of the retention feature with a latch groove in the male stem (step 525). In an example, step 525 may include aligning a portion of the stem ramp with the latch groove (step 530). The method 500 may include inserting a ferrule onto the male stem(step 535). The method 500 may include contacting a latch of the ferrule that extends radially inward with an outer surface of the retention feature (step 540). In an example, step 540 may include contacting the latch with a ferrule ramp of the retention feature that extends radially outward (step 545).

The method 500 may include pushing the ferrule over the retention feature and forcing the retention feature radially inward (step 550). The retention feature may flex radially inward so that the ferrule may be pushed over the retention feature. The ferrule may ride against the sloped ferrule ramp to force the retention feature inward. The method 500 may include aligning the latch with the latch groove of the male stem (step 555).

In another example, the method may begin with inserting a retainer into a ferrule. The method may include contacting an outer surface of the retainer with a groove or shoulder inside the ferrule. The method may include pushing the retainer, housed within the ferrule, over the stem. A retention feature of the retainer may flex outward during so that the retention feature may ride up and over a shoulder of the stem or into a groove on the stem.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps.

What is claimed is:

1. A hose coupling assembly comprising:
a male stem including an elongated body with a latch groove;
a ferrule including a latch; and
a retainer configured to be disposed on at least one of the male stem and the ferrule, and configured to couple the ferrule to the male stem such that the latch is aligned with the latch groove.

2. The hose coupling assembly of claim 1, wherein the retainer comprises a collar that axially locates the ferrule relative to the male stem.

3. The hose coupling assembly of claim 2, wherein the collar has a complete circumference.

4. The hose coupling assembly of claim 1, wherein the retainer comprises a ferrule retention feature that extends away from a first surface of a collar.

5. The hose coupling assembly of claim 4, wherein the ferrule retention feature extends orthogonally away from the first surface of the collar.

6. The hose coupling assembly of claim 4, wherein the ferrule retention feature comprises at least one flexible arm, each flexible arm having:
a stem ramp that extends radially inward;
a ferrule ramp that extends radially outward; and
a channel formed between the ferrule ramp and the first surface of the collar.

7. The hose coupling assembly of claim 6, wherein in a first position, the retainer is positioned between a shoulder and the second end of the male stem and the stem ramp of the retention feature contacts the shoulder of the male stem and the flexible arm is forced radially outward.

8. The hose coupling assembly of claim 7, wherein in a second position, the retainer is positioned about the shoulder of the male stem and a portion of the stem ramp is positioned within the latch groove.

9. The hose coupling assembly of claim 8, wherein in a third position, the ferrule is positioned about the shoulder of the male stem and the latch of the ferrule contacts the ferrule ramp of the retention feature and the flexible arm is forced radially inward.

10. The hose coupling assembly of claim 6, wherein in an assembled position, the latch is positioned within the channel of the retainer, and the ferrule is coupled to the male stem.

11. The hose coupling assembly of claim 6, wherein the stem ramp is sloped radially inward between a first end and a second end.

12. The hose coupling assembly of claim 6, wherein the ferrule ramp is sloped radially inward between a first end and a second end.

13. The hose coupling assembly of claim 6, wherein the stem ramp of the retainer has a length that is shorter than a length of the latch groove of the male stem.

14. The hose coupling assembly of claim 6, wherein the channel of the retainer has a length that is longer than a length of the latch of the ferrule.

15. A method of assembling a hose coupling assembly, the method comprising:
contacting an inner surface of a retainer with a shoulder of a male stem;
deflecting, via the shoulder, a retention feature of the retainer radially outwards;
aligning a portion of the retention feature with a latch groove defined in the male stem;
contacting a latch of a ferrule with an outer surface of the retention feature;
deflecting, via the latch, the retention feature radially inward; and
aligning the latch with the latch groove of the male stem.

16. The method of claim 15, wherein contacting the inner surface of the retainer includes contacting the shoulder of the male stem with a stem ramp of the retention feature that extends radially inwards.

17. The method of claim 16, wherein aligning the portion of the retention feature with the latch groove defined in the male stem includes aligning a portion of the stem ramp with the latch groove.

18. The method of claim 15, wherein contacting the latch with the outer surface of the retention feature includes contacting the latch with a ferrule ramp of the retention feature that extends radially outward.

19. A hose coupling assembly comprising:
a male stem with a latch groove;
a ferrule including a latch; and
a retainer with a ferrule retention feature including:
a collar including a first surface;
a stem ramp that extends away and radially inward from the first surface of the collar;
a ferrule ramp coupled with the stem ramp and that extends radially outward; and
a channel formed between the ferrule ramp and the first surface of the collar;
wherein the stem ramp is received in the latch groove and the latch is received in the channel to secure the ferrule to the male stem.

20. The hose coupling assembly of claim 19, wherein the stem ramp and ferrule ramp are sloped between a first end of the retainer and a second end of the retainer.
